(19) United States
(12) Patent Application Publication
(10) Pub. No.: US 2026/0066674 A1
(43) Pub. Date: Mar. 5, 2026

(54) SOLAR ENERGY MOBILE PHONE CASE/ BACK COVER

(71) Applicant: Ricardo Santos Comaduran, Escondido, CA (US)

(72) Inventor: Ricardo Santos Comaduran, Escondido, CA (US)

(21) Appl. No.: 18/821,927

(22) Filed: Aug. 30, 2024

(51) Int. Cl. H02J 7/35; H02J 7/00; H02S 10/40; H04M 1/72409

(52) U.S. Cl. CPC H02J 7/35; H02J 7/61; H02J 7/65; H02J 7/731; H02J 7/80; H02S 10/40; H04M 1/724092

(57) ABSTRACT

The Smart Energy Consumption Monitoring System with Integrated Fast Charging and Solar Power provides a comprehensive solution for monitoring and managing energy usage in real-time for mobile devices. The system integrates sensors, data processing units, machine learning algorithms, solar panels, an MPPT module, and a fast-charging module to optimize energy consumption, promote efficiency, and ensure sustainable power supply.

### BACKGROUND OF THE INVENTION

The increasing dependence on mobile devices has led to a growing demand for sustainable and efficient charging solutions. Traditional charging methods rely heavily on grid power, which can be inefficient and environmentally unfriendly. Renewable energy sources, such as solar power, offer a promising alternative. Solar energy has been harnessed for various applications, including calculators, streetlights, and home energy systems. Integrating solar power into mobile phone accessories, such as cases or back covers, can provide a sustainable solution to extend battery life and reduce reliance on conventional power sources.

### SUMMARY OF THE INVENTION

The Solar Energy Mobile Phone Case/Back Cover is designed to harness solar energy to charge mobile devices, specifically the iPhone 15 Pro and Samsung S24. The invention includes solar panels, an MPPT (Maximum Power Point Tracking) module, a fast-charging module, a USB-C connector board, and an energy consumption monitoring system. The integrated system allows for efficient energy harvesting, real-time monitoring of energy consumption, and optimized charging of mobile devices.

### DETAILED DESCRIPTION OF THE INVENTION

The Solar Energy Mobile Phone Case includes the following components:

### Solar Panels

The solar panels are embedded into the back cover of the phone case and are made from high-efficiency monocrystalline silicon, known for its superior power conversion capabilities even in low-light conditions. The panels are protected by a durable, scratch-resistant cover that ensures longevity without compromising on energy absorption.

### MPPT Module (CN3791)

The Maximum Power Point Tracking (MPPT) module is critical for optimizing the power output from the solar panels. It dynamically adjusts the operating point of the panels to ensure that they operate at their peak efficiency under varying environmental conditions. The CN3791 specifically includes adaptive algorithms that cater to the fluctuations in sunlight intensity, thereby maximizing energy capture throughout the day.

### Fast Charging Module (SM 5308)

The fast-charging module is designed to minimize the time required to charge the mobile device. This module is compatible with various fast-charging standards, including USB Power Delivery (USB-PD) and Qualcomm Quick Charge. The SM 5308 ensures that the mobile device charges rapidly without overheating, by incorporating thermal management and overcharge protection mechanisms.

### USB-C Connector Board

The USB-C connector board serves as the interface between the solar charging system and the mobile device. It supports both charging and data transfer, ensuring that users do not have to disconnect the solar case for standard USB functions. The board is designed to meet the USB 3.1 specifications, providing fast data transfer rates along with reliable power delivery.

### Energy Consumption Monitoring System

The energy consumption monitoring system consists of a network of sensors placed strategically within the phone case. These sensors track real-time energy usage by the mobile device and the solar charging system. Data collected by the sensors is processed by a central unit that uses machine learning algorithms to analyze energy consumption patterns. The system then provides optimization recommendations to the user via a mobile application, which displays energy usage statistics, charging status, and suggested actions to enhance efficiency.

### User Interface and Mobile Application

The user interface is accessible through a mobile application compatible with both iOS and Android platforms. This application allows users to monitor the charging process in real-time, view historical energy consumption data, and receive optimization tips. Additionally, the app can issue alerts for abnormal energy consumption patterns, potentially indicating issues with the charging system or device.

### Battery Integration

As an optional feature, the case can be equipped with a built-in lithium-polymer (LiPo) battery, which stores excess energy generated by the solar panels. This stored energy can be used to charge the device when solar energy is unavailable, such as during nighttime or cloudy weather conditions. The battery is managed by the same MPPT and fast-charging modules to ensure efficient energy use and safe charging.

### Durability and Aesthetic Design

The phone case is constructed from high-grade polycarbonate materials, offering robust protection against drops and impacts while maintaining a sleek and modern design. The integration of solar panels is done in a manner that does not significantly increase the bulk of the device, ensuring it remains portable and aesthetically pleasing.

### Operational Flow

Solar Energy Collection: Solar panels capture sunlight and convert it into electrical energy.
Energy Optimization: The MPPT module maximizes the efficiency of power conversion, adapting to varying sunlight conditions.
Data Collection: Sensors within the case monitor real-time energy usage by the device and the charging system.
Data Processing: The central data processing unit utilizes machine learning to analyze the collected data.
Pattern Analysis: Historical data is analyzed to identify usage patterns and optimize energy efficiency.
Optimization Recommendations: The system provides actionable suggestions to the user via the mobile app.
Fast Charging: The fast-charging module ensures the device is charged rapidly without compromising safety.
User Interaction: Users can interact with the system through the mobile app, which offers insights and control over energy usage.

### BRIEF DESCRIPTION OF THE DRAWINGS

FIG. 1: This view will show the overall design and assembly of the Solar Energy Mobile Phone Case. It provides a 3D perspective, which helps in understanding the spatial arrangement of the components.

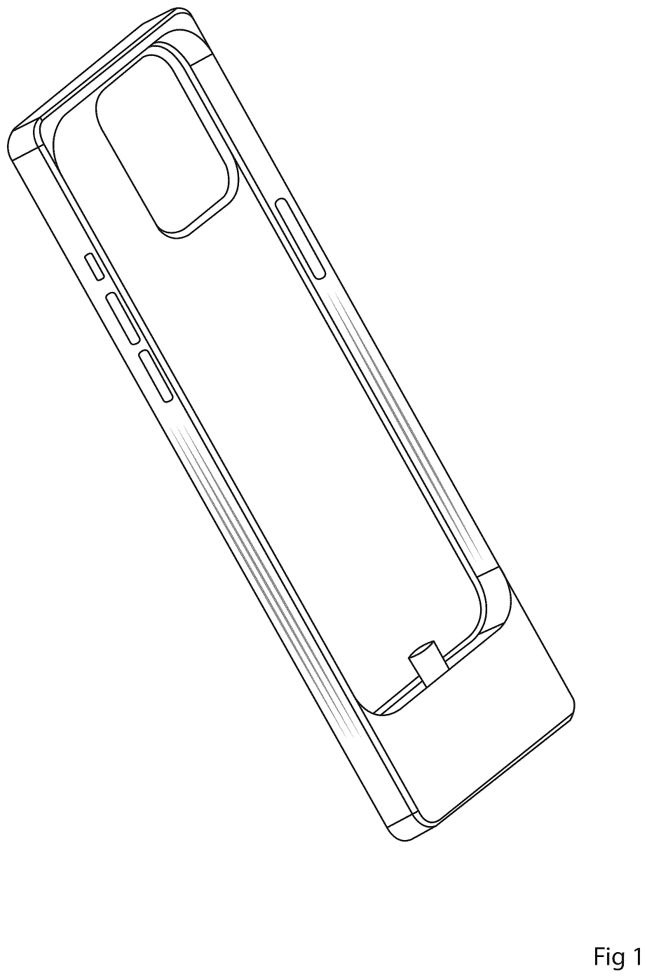

FIG. 2: The front view of the phone case should clearly illustrate the solar panels integrated into the back cover. This view will highlight the positioning and coverage of the solar panels.

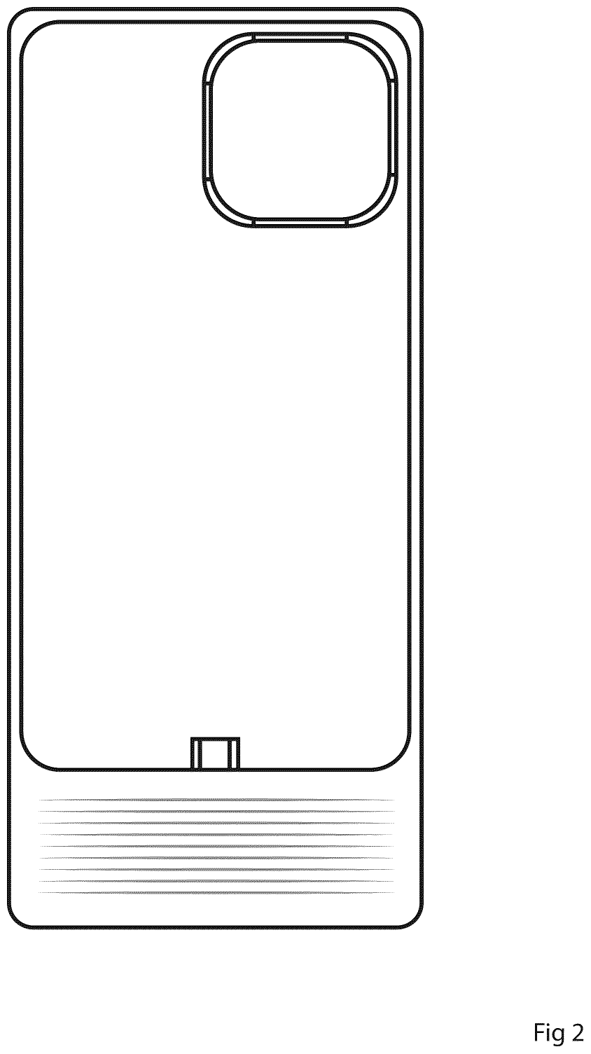

FIG. 3: The rear view should focus on the detailed layout of the solar panels, the USB-C connector board, and the fast-charging module. It will show the external appearance when the phone is placed face-down.

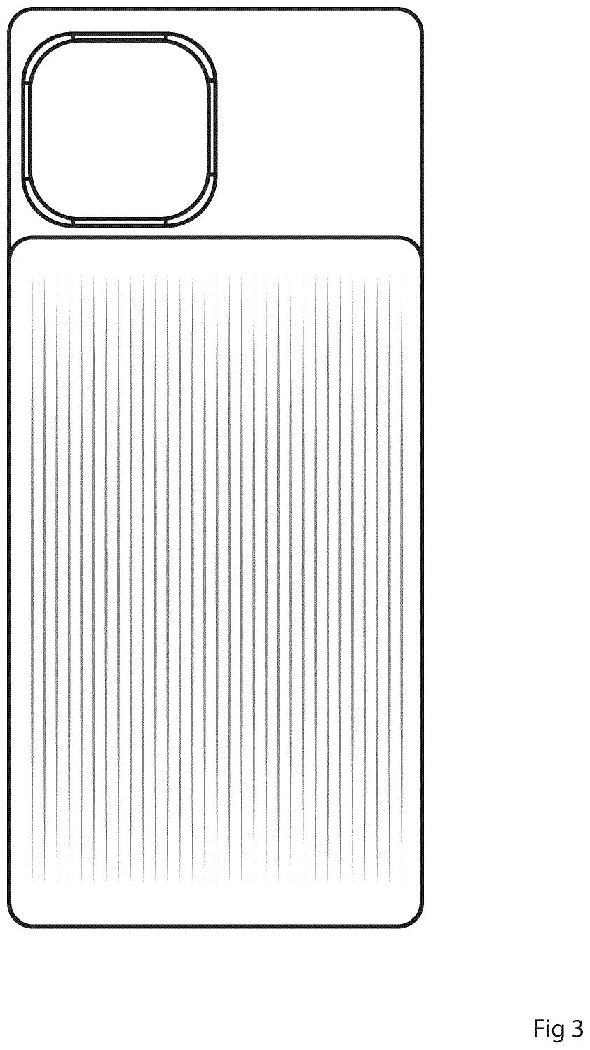

FIG. 4: These views will display the thickness of the phone case, the placement of the MPPT module, and any other side-specific features like buttons or connectors. Both left and right sides should be shown to cover all aspects.

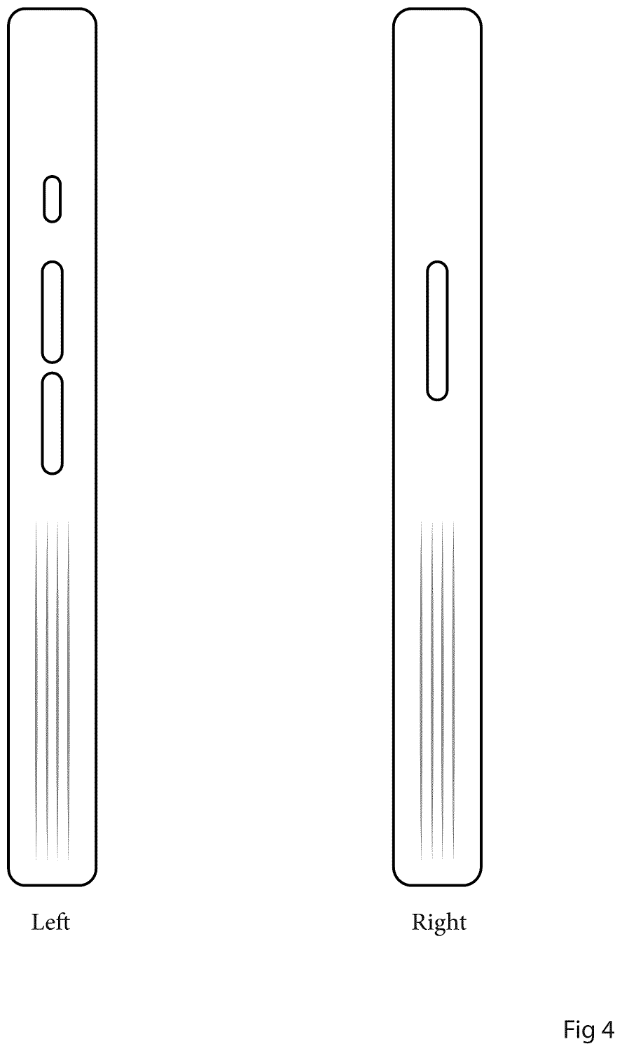

FIG. 5: These views will provide detailed illustrations of the connectors and ports, such as the USB-C connector board. They will also show the alignment and positioning of the solar panels relative to the edges of the phone case.

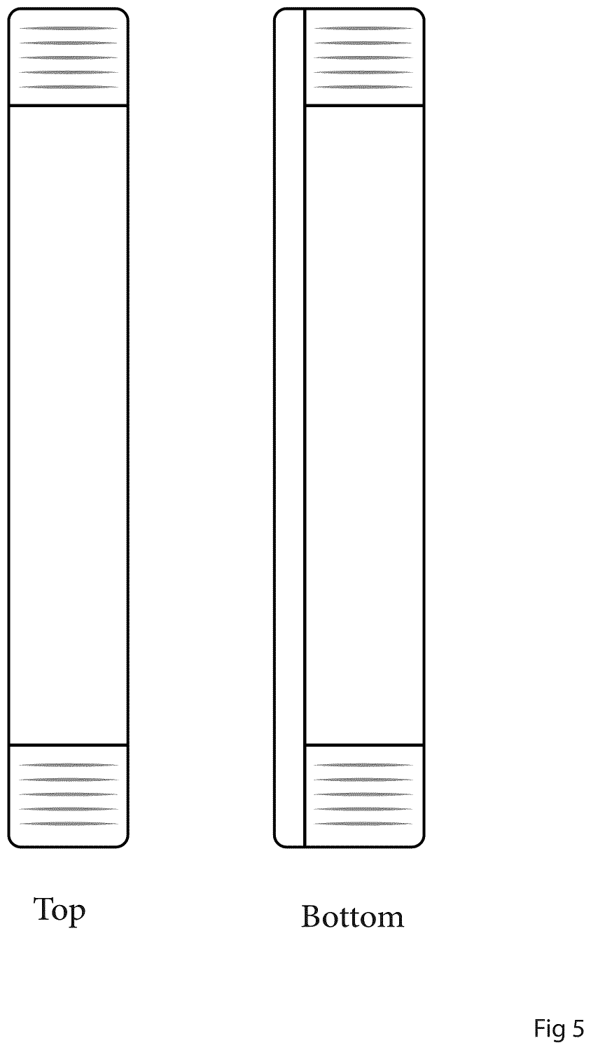

FIG. 6: An exploded view is essential to illustrate the internal components separately, such as the solar panels, MPPT module, fast-charging module, USB-C connector board, sensors, and the LiPo battery. This view will show how all parts fit together and their individual placements within the phone case.

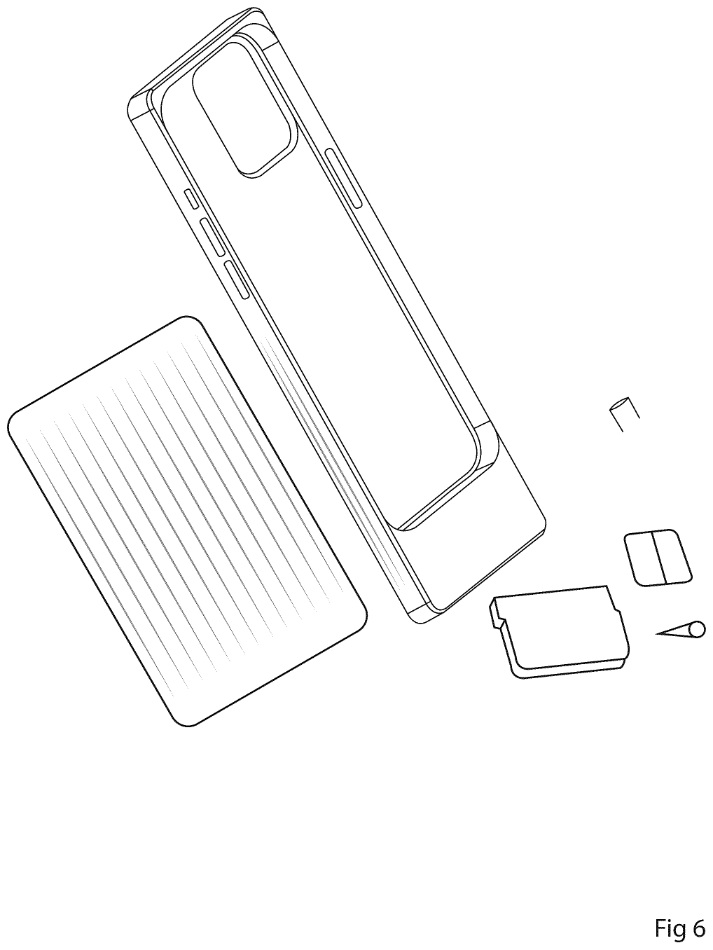

1. A smart energy consumption monitoring system integrated with fast charging and solar power for a mobile device, comprising:
I. Solar panels integrated into the phone case for sustainable power generation;
II. An MPPT (Maximum Power Point Tracking) module to optimize the efficiency of solar energy conversion;
III. A fast-charging module compatible with USB-PD and Qualcomm Quick Charge standards for rapid charging;
IV. Sensors for measuring real-time energy usage by the mobile device and charging system;
V. A central data processing unit equipped with machine learning algorithms for analyzing energy consumption patterns and optimizing energy usage;
VI. A user interface accessible via a mobile application for displaying real-time energy information, historical data, and optimization recommendations;
VII. A USB-C connector board to facilitate connectivity between the solar charging system and the mobile device, supporting both charging and data transfer;
VIII. An optional lithium-polymer (LiPo) battery for storing excess solar energy for later use.

2. The system of claim 1, wherein the solar panels are made of high-efficiency monocrystalline silicon and are protected by a durable, scratch-resistant cover.

3. The system of claim 1, wherein the fast-charging module includes thermal management and overcharge protection mechanisms.

4. The system of claim 1, wherein the user interface provides alerts for abnormal energy consumption patterns indicating potential issues with the charging system or mobile device.

5. The system of claim 1, wherein the mobile application is compatible with both iOS and Android platforms, allowing users to monitor and manage energy usage on various devices.

6. The system of claim 1, further comprising an integrated lithium-polymer (LiPo) battery managed by the MPPT and fast-charging modules, to store and provide power during periods of insufficient sunlight.

7. The system of claim 1, wherein the solar panels, MPPT module, and fast charging module are all housed within a high-grade polycarbonate case designed to protect the mobile device from drops and impacts.
